(19) United States
(12) Patent Application Publication
(10) Pub. No.: US 2016/0068356 A1
(43) Pub. Date: Mar. 10, 2016

(54) System and Method for Reusing or Recycling Building Material

(71) Applicant: MARTIN INDARS, WEST CHESTER, PA (US)

(72) Inventor: MARTIN INDARS, WEST CHESTER, PA (US)

(21) Appl. No.: 14/837,034

(22) Filed: Aug. 27, 2015

Related U.S. Application Data
(60) Provisional application No. 62/045,600, filed on Sep. 4, 2014.

(51) Int. Cl. B65G 67/14; B08B 1/00; B65G 67/08

(52) U.S. Cl. CPC B65G 67/14; B65G 67/08; B08B 1/005

(57) ABSTRACT

A system for reusing one or more masonry units can include a vehicle having at least one vertical lift. The lift can be movable with respect to the vehicle from a lower, compact position to a higher, extended position. At least one collection bin can include a first end, an opposing second end, and a longitudinal axis extending therebetween. A plurality of elongated slots can extend along the longitudinal axis of the collection bin. Each slot can include an open first end and an opposing second end. The first end of each slot can be sized and shaped to receive at least one masonry unit therein. A conveyor can extend from proximate to one or more masonry units to proximate to the first end of the collection bin. The conveyor can be configured to supply at least one of the masonry units to the collection bin.

### CROSS-REFERENCE TO RELATED APPLICATION

The present application claims priority to U.S. Provisional Patent Application No. 62/045,600, which was filed on Sep. 4, 2014 and titled “System and Method for Reusing or Recycling Building Material,” which is herein incorporated by reference in its entirety.

### BRIEF SUMMARY

The present disclosure relates generally to a system and method for reusing or recycling building material and, more particularly, to a system and method for collecting used or weathered masonry units, removing at least some mortar or other debris from one or more of the masonry units, and organizing the generally cleaned masonry units for later use.

Devices and method for manufacturing and moving masonry units or brick are generally known. For example, U.S. Pat. No. 4,040,532 (Pearne), titled “Brick Handling System,” relates to manufacturing and moving bricks out of a kiln more efficiently. U.S. Pat. No. 4,787,812 (Gopfert), titled “Apparatus for Lifting Arrays of Paving Stones and the Like,” discloses a mobile arm and suction cups to transport bricks, stones, etc., from a delivery truck to a bricklayer.

However, the prior art fails to disclose or even suggest a system or method to allow a single individual to efficiently collect, clean, organize, and/or at least temporarily store used or weathered masonry units for later use. The system and method of the present disclosure overcomes the above-identified disadvantages of the prior art, and provides the above and additional benefits.

In one embodiment, the present disclosure is directed generally to a system for reusing one or more masonry units that can include a vehicle having at least one vertical lift. The lift can be movable with respect to the vehicle from a lower, compact position to a higher, extended position. At least one collection bin can include a first end, an opposing second end, and a longitudinal axis extending therebetween. A plurality of elongated slots can extend along the longitudinal axis of the collection bin. Each slot can include an open first end and an opposing second end. The first end of each slot can be sized and shaped to receive at least one masonry unit therein. The collection bin can be placed on the vehicle. The first end of the collection bin can be positioned proximate to the vertical lift. A conveyor can extend from proximate to one or more masonry units to proximate to the first end of the collection bin. The conveyor can be configured to supply at least one of the masonry units to the collection bin.

In another embodiment, the present disclosure is directed to a method of reusing masonry units. The method can include receiving masonry units in a single file manner, inserting a predetermined number of the masonry units into a first slot of a collection bin in a single file manner, and inserting a predetermined number of masonry units into a second slot of the collection bin in a single file manner. The first slot can be horizontally or vertically adjacent to the second slot. The method can further include raising a pallet to be at least generally level with the first and second slots, and ejecting at least some of the masonry units from each slot in a single file manner onto the pallet. The masonry units can be ejected to form an organized pattern on the pallet. The method can also include lowering the pallet once a desired number of masonry units are placed thereon.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a perspective view of at least a portion of an apparatus, system and method for reusing or recycling building material according to an embodiment of the present disclosure;

FIG. 2 is another perspective view thereof;

FIG. 3 is yet another perspective view thereof;

FIG. 4 is a further perspective view thereof;

FIG. 5 is still a further perspective view thereof;

FIG. 6 is another perspective view thereof

FIG. 7 is yet another perspective view thereof;

FIG. 8 is a further perspective view thereof;

FIG. 9 is a partially exploded perspective view of a portion of the apparatus;

FIG. 10 is another perspective view of a portion of the apparatus, system and method;

FIG. 11 is yet another perspective view thereof;

FIG. 12 is a further perspective view thereof;

FIG. 13 is still a further perspective view thereof;

FIG. 14 is another perspective view thereof;

FIG. 15 is yet another perspective view thereof;

FIG. 16 is a perspective view of a portion of an apparatus, system and method for reusing or recycling building material according to another embodiment of the present disclosure;

FIG. 17 is an enlarged perspective view thereof;

FIG. 18 is a cross-sectional elevation view of a mortar removal device according to an embodiment of the present disclosure;

FIG. 19 is a perspective view of a mortar removal device according to an embodiment of the present disclosure, wherein a portion of the device is shown as being transparent for clarity;

FIG. 20 is another perspective view of the apparatus, system and method shown in FIG. 16;

FIG. 21 is a cross-sectional elevation view of a chute according to an embodiment of the present disclosure; and

FIG. 22 is a perspective view of one embodiment of the apparatus of the present disclosure, wherein portions of the apparatus are removed to show internal components thereof.

### DETAILED DESCRIPTION

Certain terminology is used in the following description for convenience only and is not limiting. The words “lower,” “top” and “upper” designate directions in the drawings to which reference is made. Unless specifically set forth herein, the terms “a,” “an” and “the” are not limited to one element but instead should be read as meaning “at least one.” The terminology includes the words noted above, derivatives thereof and words of similar import.

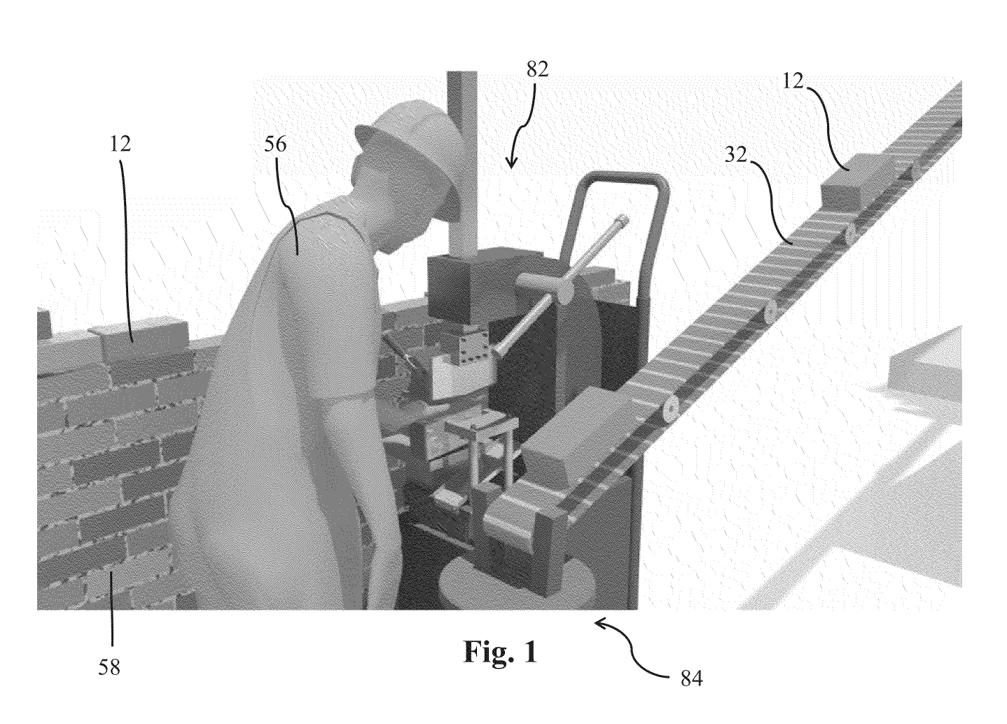

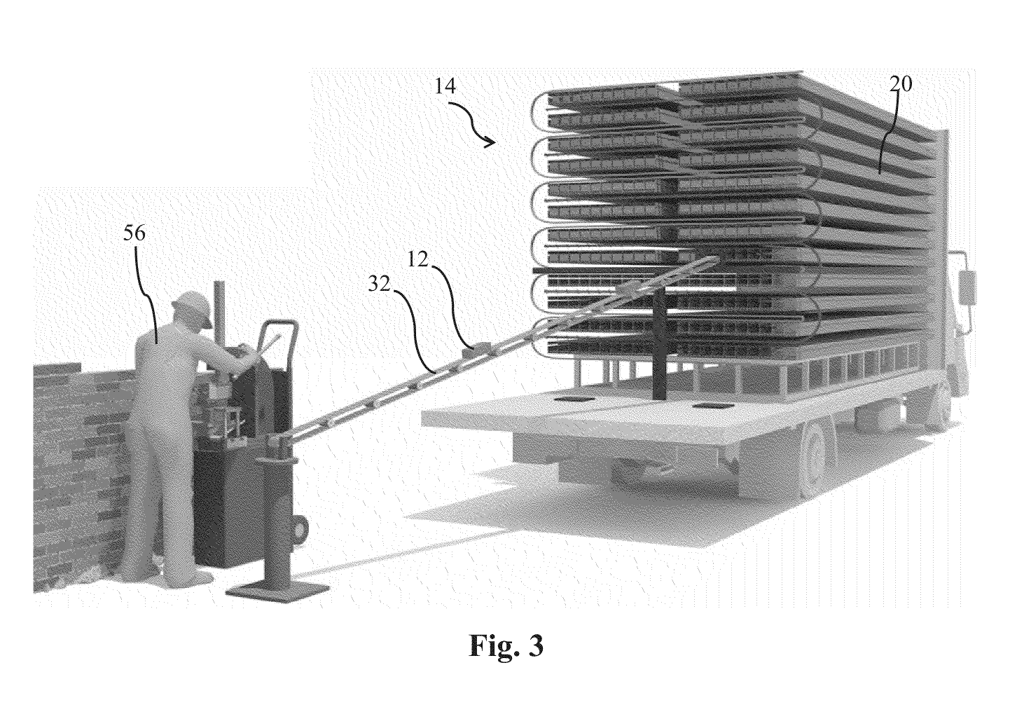

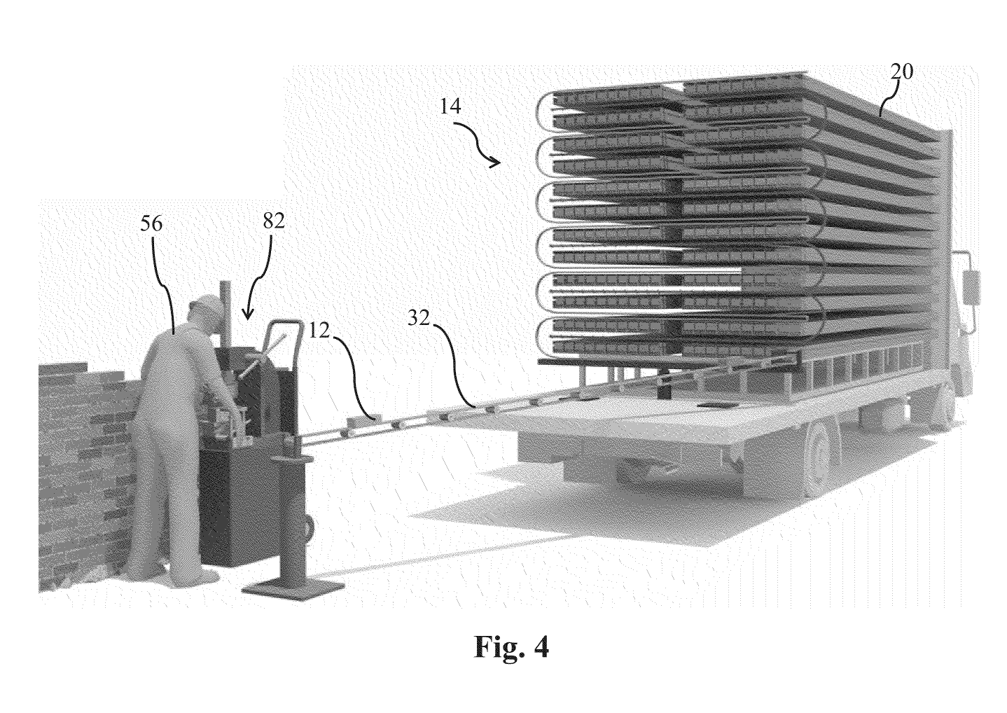

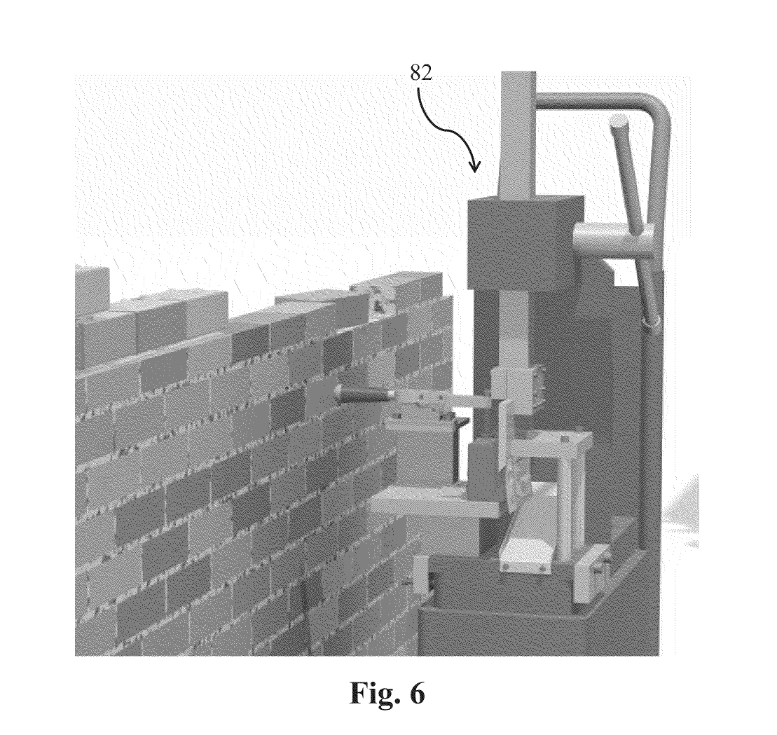

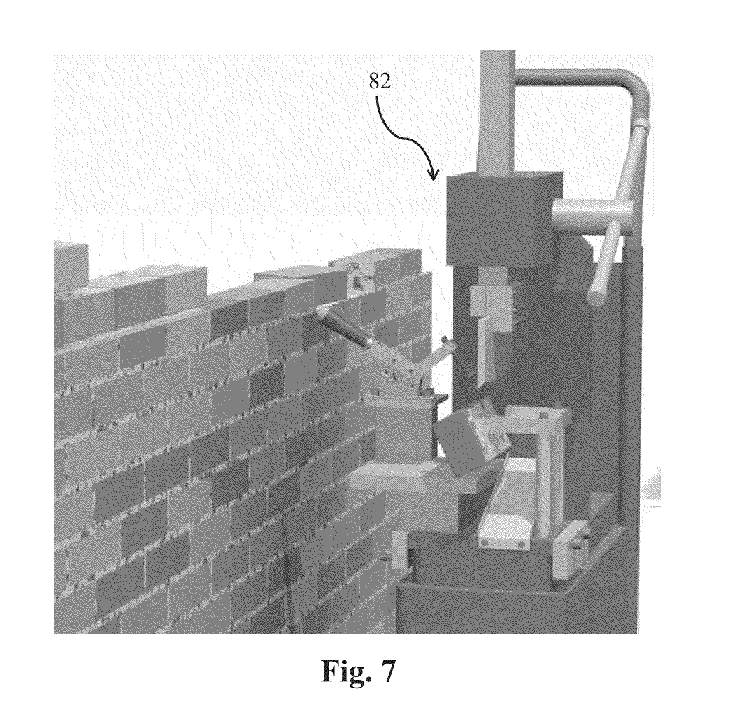

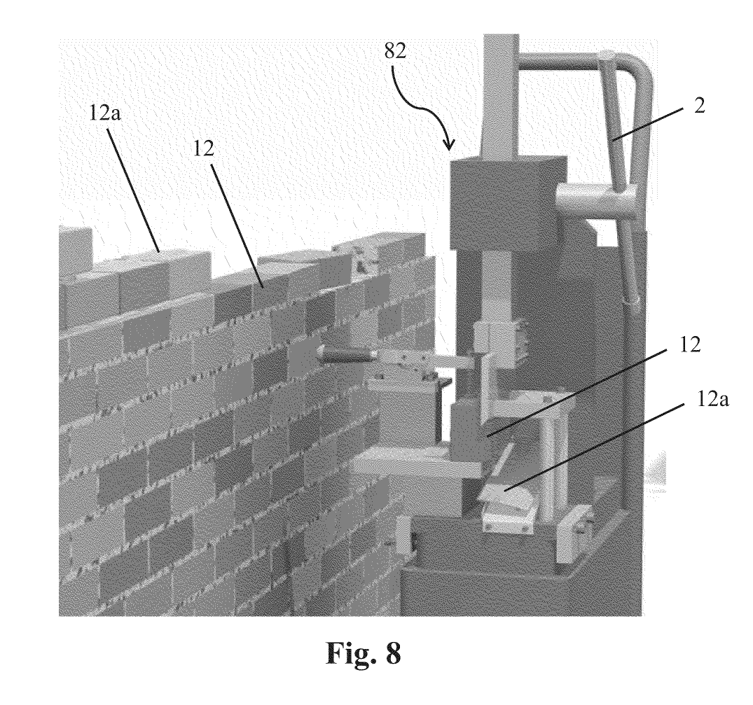

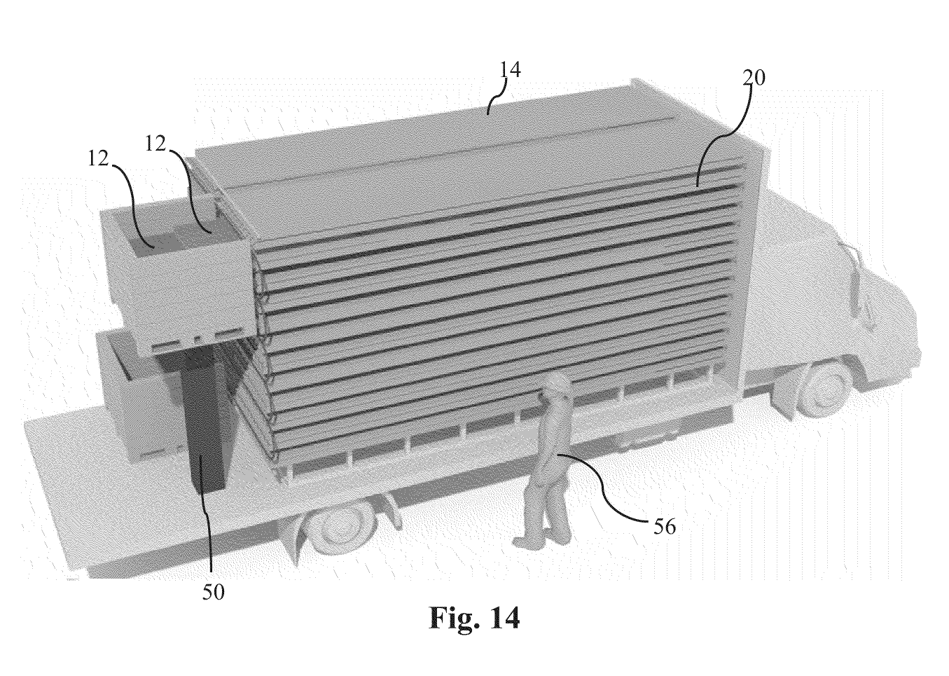

Referring to the drawings in detail, wherein like reference numerals indicate like elements throughout, FIGS. 1-15 illustrate an apparatus, system and method for reusing or recycling one or more masonry units, generally designated 12. The masonry units 12 can be bricks, stones, pavers, Belgian block, concrete block, cobble stone, or the like, or any combination thereof. Although bricks 12 are shown in the drawings, it is understood that the present disclosure is not limited to any particular type, size, shape or style of masonry unit.

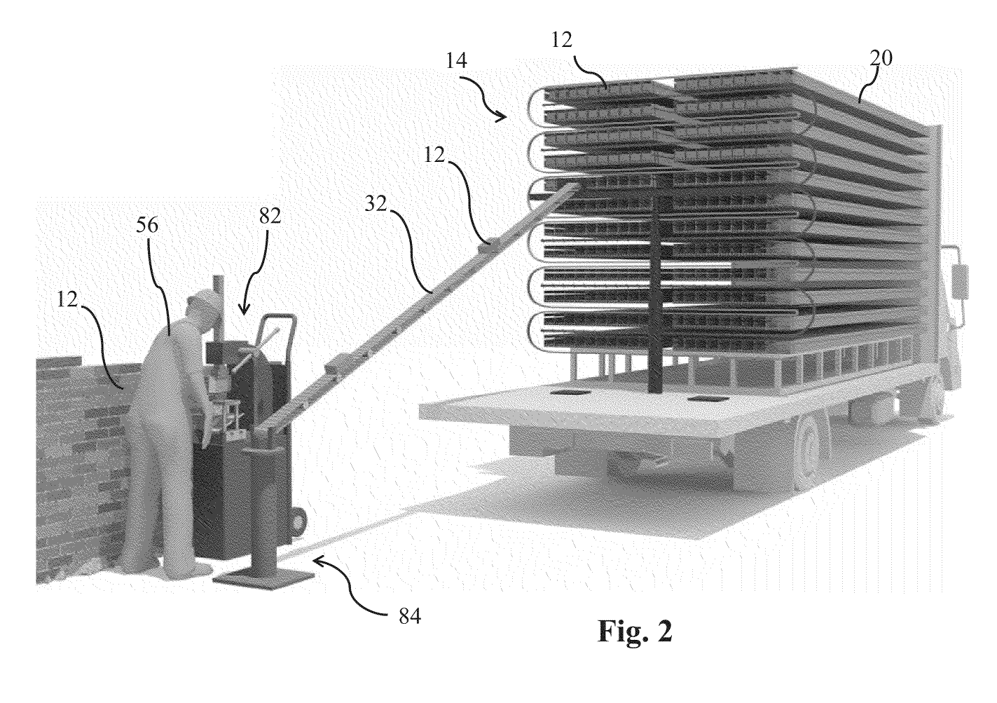

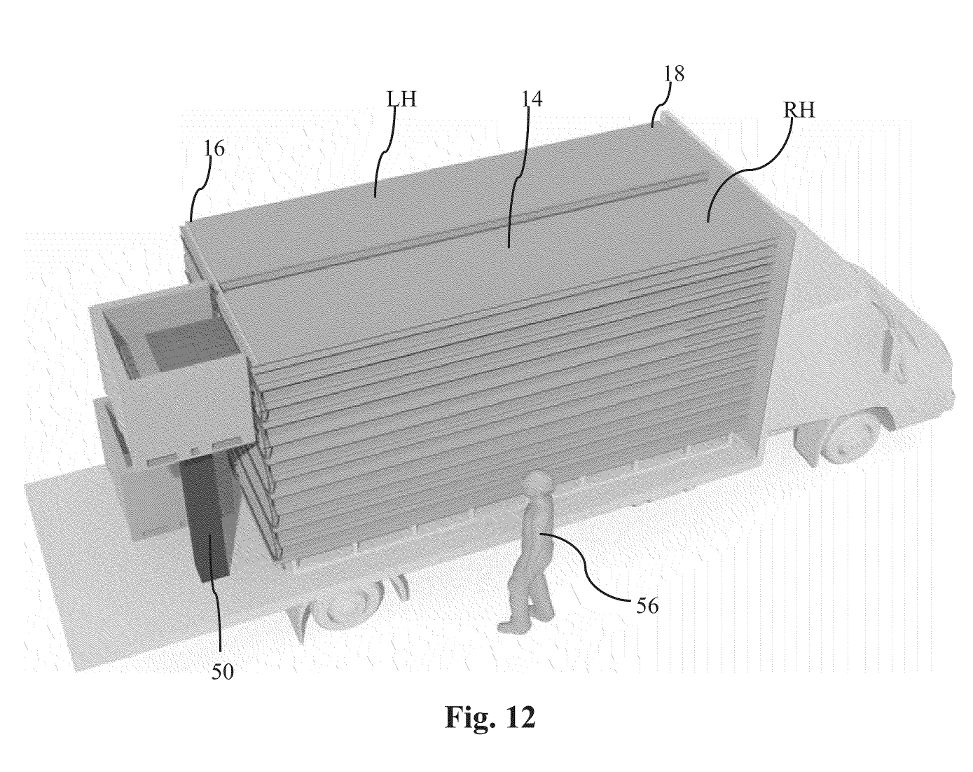

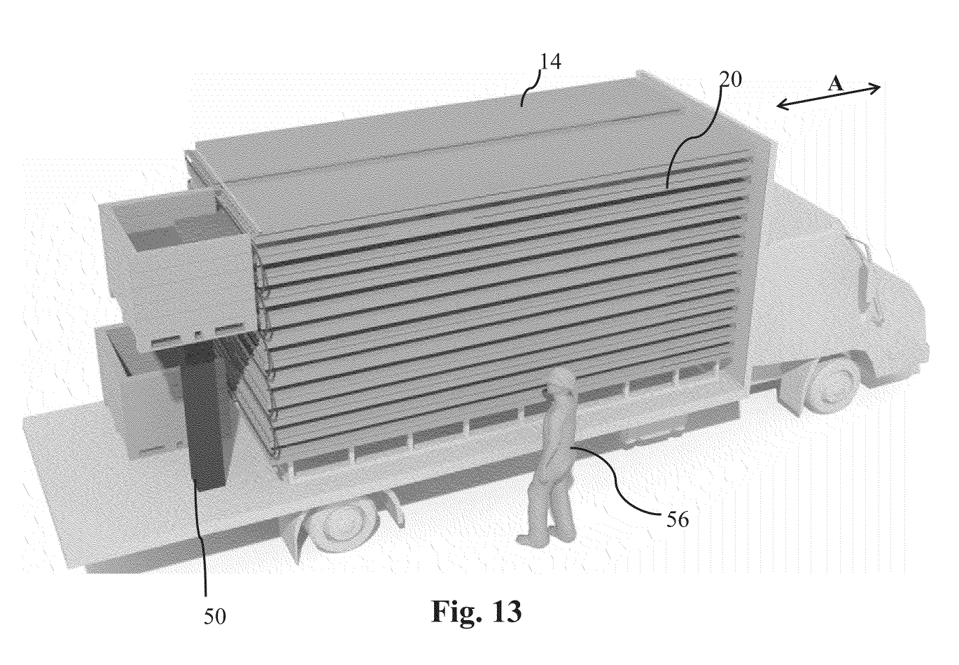

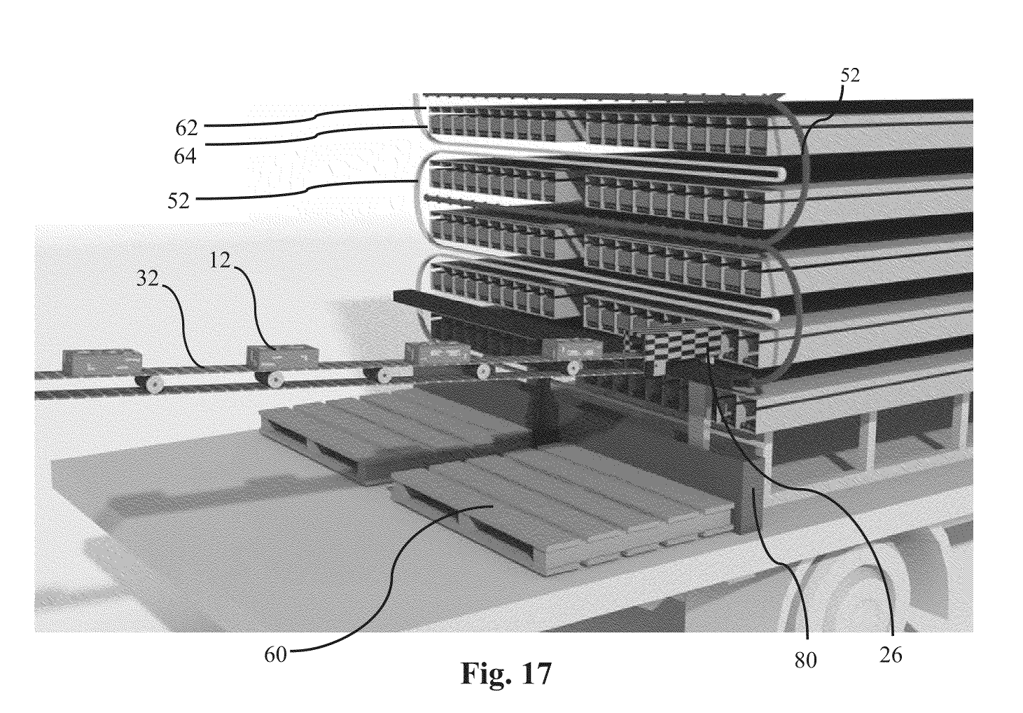

Referring to FIGS. 2-4 and 10-15, the system can include one or more collection bins, generally designated 14. Each collection bin 14 can include a first or front end 16, an opposing second or rear end 18 (see FIG. 12), and a longitudinal axis A (see FIG. 13) extending therebetween. The collection bin 14 can be divided in two halves LH, RH (see FIG. 12) along the longitudinal axis. A width (measured perpendicularly to the longitudinal axis A) of each half LH, RH can be approximately equal to a width of a standard pallet 60 (see FIG. 17). The size, shape and/or configuration of each collection bin 14 are not limited to that shown and described herein.

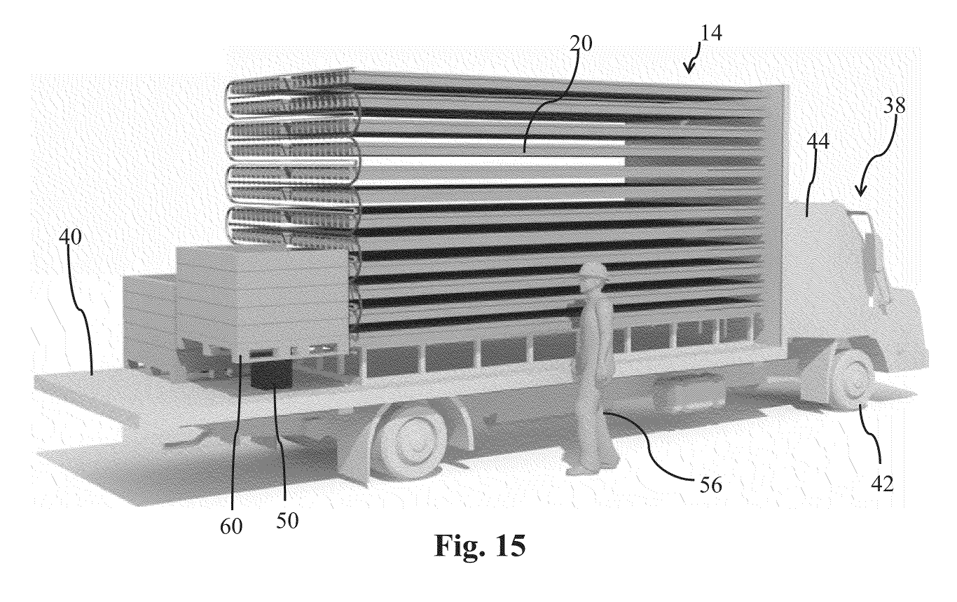

The collection bin 14 can be permanently stationary or movable. For example, as shown in FIG. 15, the collection bin 14 can be placed on or affixed to at least a portion of a vehicle, such as flatbed truck 38, a pulled cart, a trailer or a pick-up truck, for example. The flatbed truck 38 can include a platform 40 supported above a plurality of wheels 42 and behind a cabin 44. The platform 40 can be longer than the collection bin 14 both in length (parallel to the longitudinal axis A) and in width (perpendicular to the longitudinal axis A). The truck 38 permits an individual to place the collection bin 14 in a desired location, such as toward the front of a construction site.

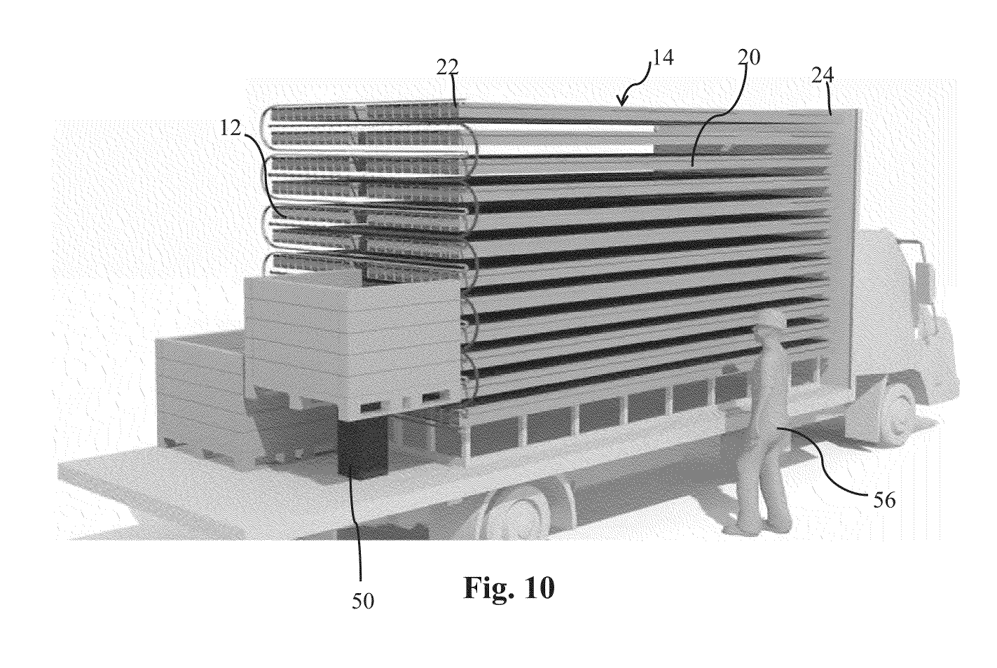

Referring to FIGS. 10-15, the system can include at least one lift or lifting mechanism 50 positioned proximate the first end 16 of the collection bin 14. In one exemplary embodiment, two spaced-apart lifts 50 can each be independently movable at least generally, if not exactly, perpendicularly to the longitudinal axis A of the collection bin(s) 14 and at least generally, if not exactly, perpendicularly to a plane defined by the platform 40 of the truck 38. In the exemplary embodiment shown herein, the lift 50 can move upwardly and downwardly in a telescoping manner, for example, from the platform 40 of the flatbed truck 38. Each lift 50 can be generally coplanar with the top surface of the platform 40 when the lifts 50 are in a lower, compact position (see FIG. 2). However, the lift(s) 50 is/are not limited to such structural and/or operational features. The lift 50 can be pneumatically, electrically, or hydraulically operated, for example.

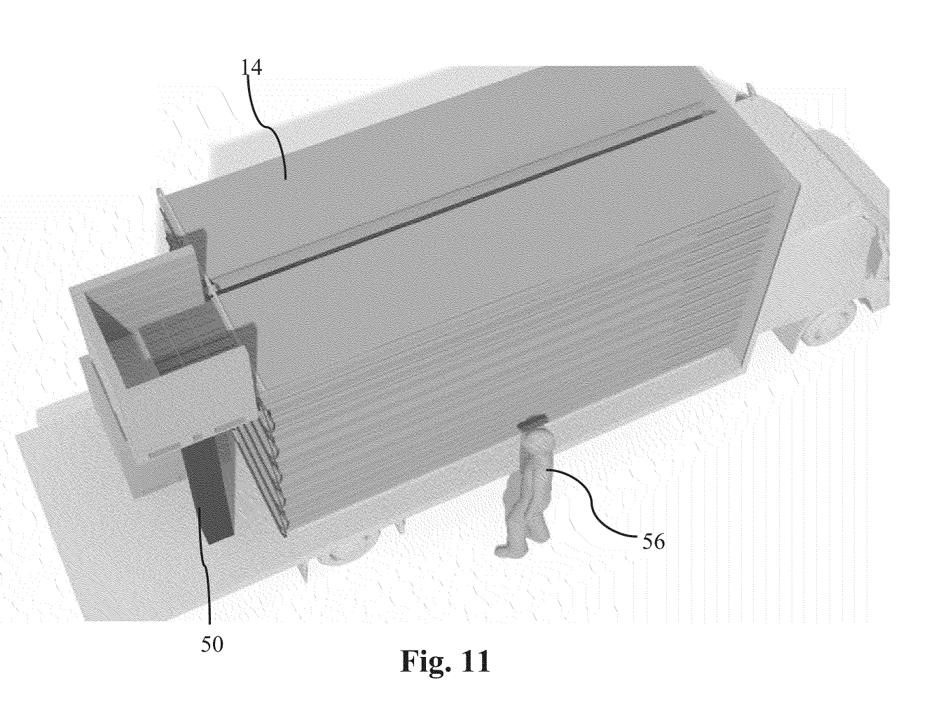

As described in detail below and shown in FIG. 11, at least a generally flat top or upper end of the lift 50 can be configured to receive and/or support one or more of the masonry units 12 that are ejected or removed from the first end 16 of the collection bin 14. In one exemplary embodiment, two spaced-apart lifts 50 are located proximate to the first end 16 of the collection bin 14. Each of the two lifts 50 can be at least generally aligned behind one of the halves LH, RH of the collection bin 14.

The system can include at least one horizontal cleat or push bar that extends at least slightly into an interior of the collection bin 14. Each push bar can have a length that is generally equal to a width of each half LH, RH of the collection bin 14. Each push bar can also extend at least slightly laterally (e.g., perpendicularly to the longitudinal axis A) outwardly from at least one side of the collection bin 14 so as to permit a user or operator 56 to engage or grab the push bar. The push bar can be movable with respect to the collection bin 14 in a direction that is at least generally, if not exactly, parallel to the longitudinal axis A. The push bar can allow the user or operator 56 to selectively remove one or more of the masonry units 12 from one or more slots of the collection bin 14.

In one exemplary embodiment, one push bar can extend inwardly from one side of the collection bin 14, and a second push bar can extend inwardly from an opposing side of the collection bin 14. The two push bars can be independently manually, electronically, hydraulically and/or pneumatically movable. Each push bar can have an extended configuration (e.g., when in use) and a collapsed configuration (e.g., for storage purposes within the collection bin 14 when not in use).

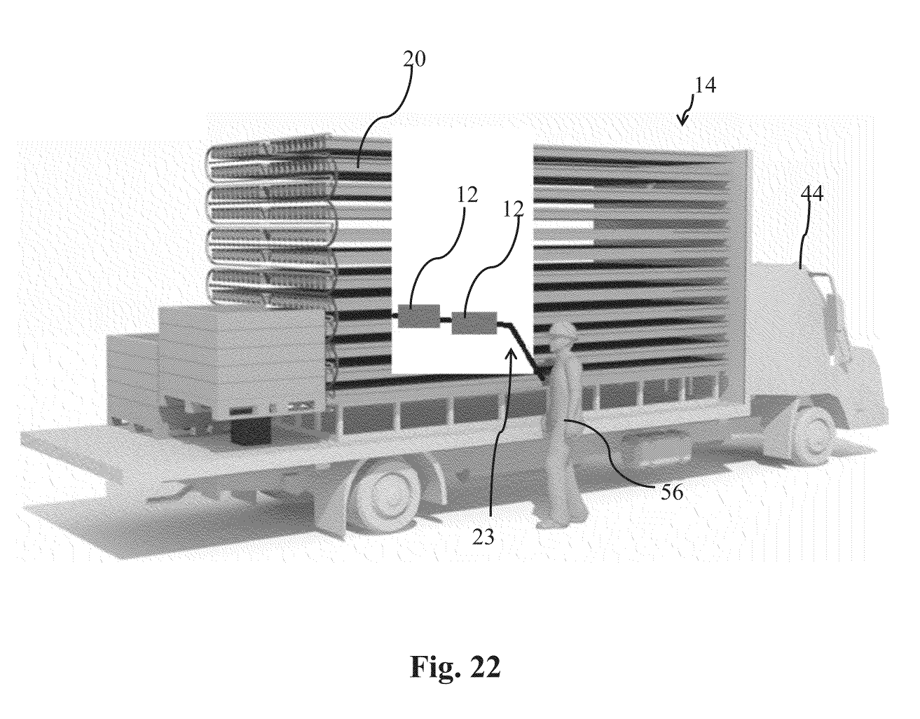

FIG. 22 shows one embodiment of the push bar, generally designated 23. The push bar 23 can include a proximal end designed to be easily grasped by the user 56 and a portion designed to engage one end or side of one or masonry units 12 to move the masonry unit(s) 12 out of the collection bin 14. As shown in FIG. 22, the push bar 23 can include a first generally linear portion that extends at an angle (e.g., approx. 45 degrees) with respect to a second generally linear portion.

The push bar 23 is not limited to the exact size, shape and/or configuration shown in FIG. 22.

As shown in FIGS. 2-4, 10 and 13-15, one, two or even a plurality of elongated storage chutes or slots 20 can extend in a direction that is at least generally, if not exactly, parallel to the longitudinal axis A of the collection bin 14. In combination, the plurality of slots 20 can form the collection bin 14. Each slot 20 can include a generally open first or front end 22 and an opposing second or rear end 24 (see FIG. 10). The first end 22 of each slot 20 can be sized and shaped to receive at least one masonry unit 12 therein and/or therethrough. In an exemplary embodiment, only one masonry unit 12 can pass through the first end 22 of each slot 20 at a time (i.e., in single file or in series). The second end 22 of each slot 20 can be generally or completely closed to prevent the masonry units 12 from exiting the slot at the second end 22. The slots 20 can be arranged in horizontal rows and vertical columns.

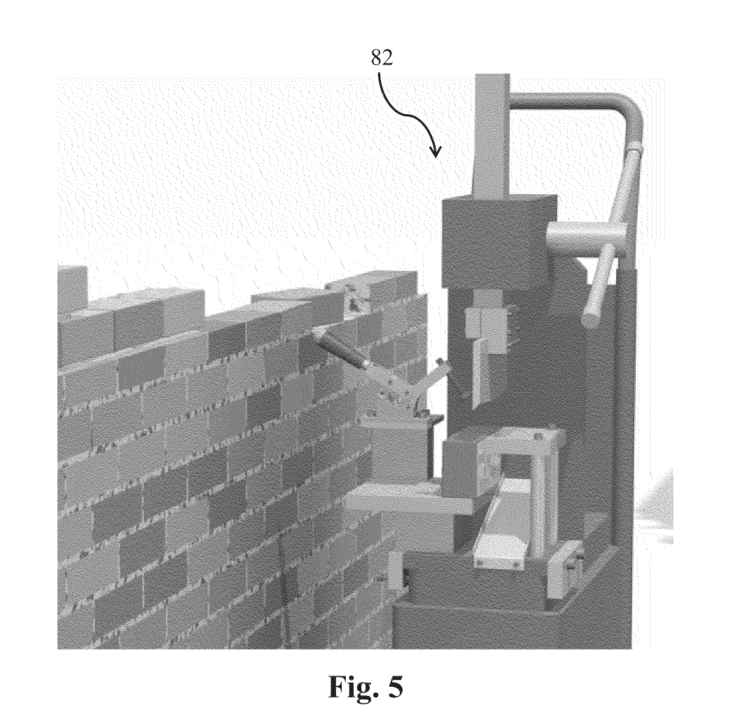

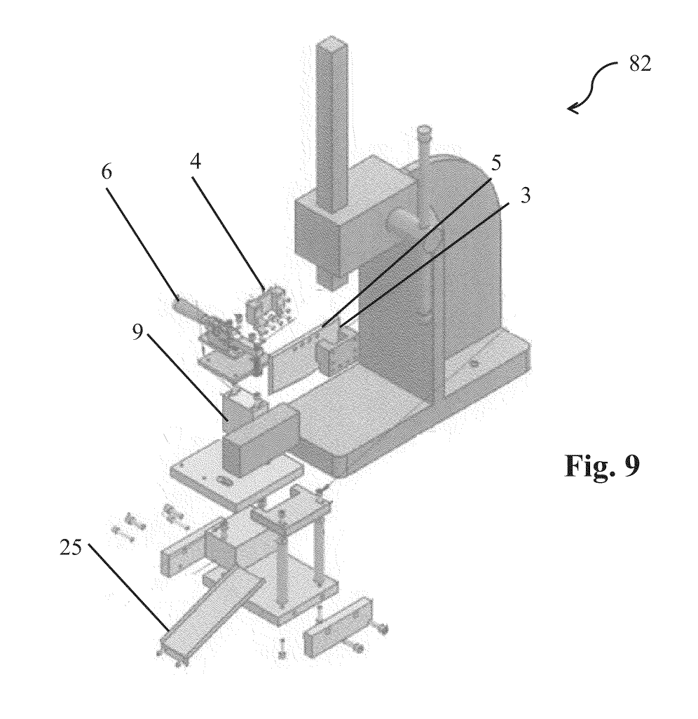

Referring to FIGS. 1-9, the system can include one or more separating mechanisms, generally designated 82. The separating mechanism 82 can be an arbor press, but the present disclosure is not so limited. The separating mechanism 82 can be placed on a dolly or hand cart to allow the user to move the separating mechanism 82 to a desired location. As shown in FIG. 9, the separating mechanism 82 can include a blade mount 3, a first clamp 4, a blade 5, a second clamp 6, a clamp spacer 9, and a slide or ramp 25. As one of ordinary skill in the art could understand from FIGS. 5-8, a handle 2 of the separating mechanism 82 can be operated by a user (e.g., rotated) to effectuate movement of the blade 5 to scrape or cut or push debris or grout from any side of a single masonry unit 12. The masonry unit 12 can be held in place while the blade 5 is in motion by the second clamp 6. As debris and/or grout is removed from the masonry unit 12 by the blade 5, the debris and/or grout can fall onto the slide and move toward and into a waste bucket or onto the ground, for example. The masonry unit 12 may need to be rotated several times while in the separating mechanism 82 to allow the blade to remove any debris and/or grout on various surfaces of the masonry unit 12.

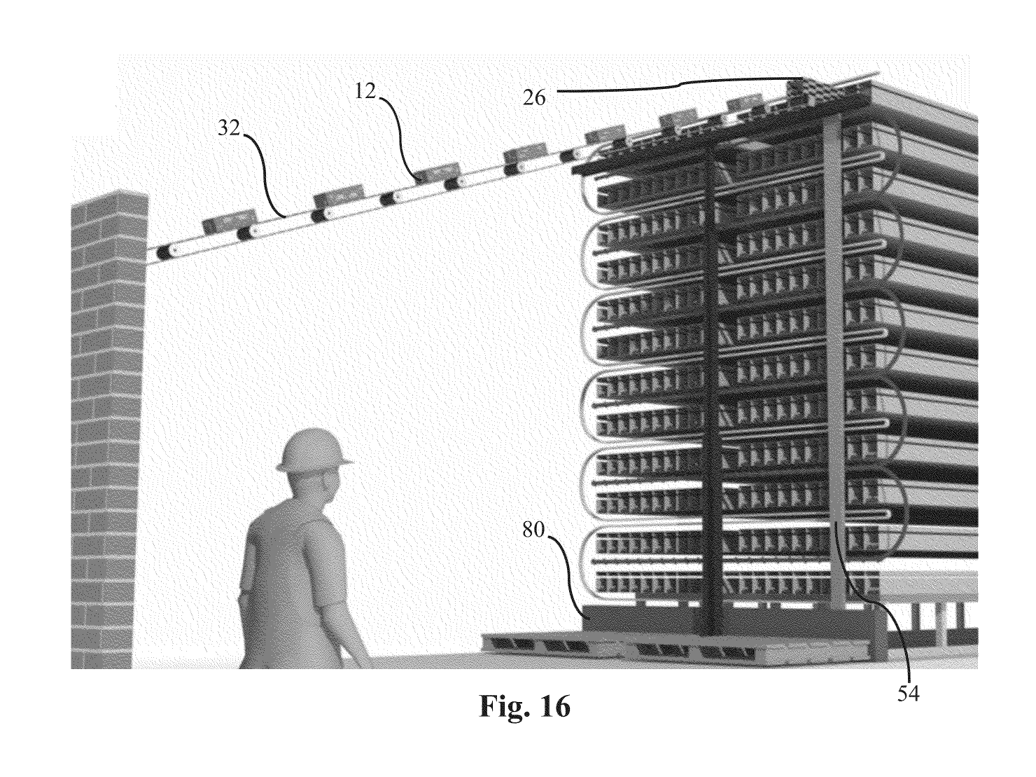

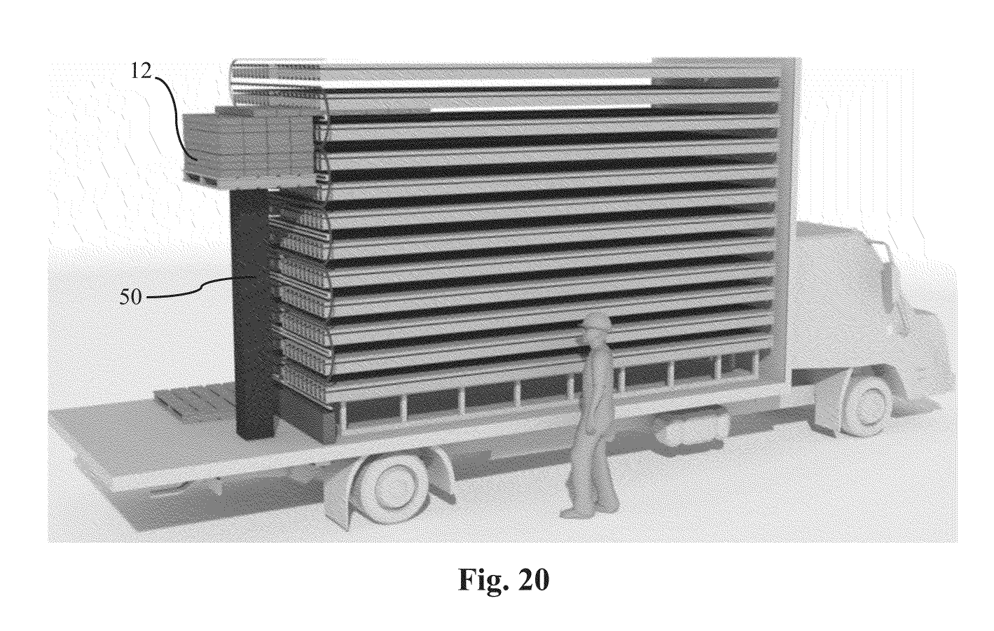

FIGS. 16-21 show portions of another preferred embodiment of an apparatus, system and method for reusing or recycling one or more masonry units 12. The embodiment of FIGS. 16-21 is substantially similar to the embodiment of FIGS. 1-15. Certain common features shown and described herein with respect to the other embodiment may be omitted herein for the sake of clarity and convenience when describing the present embodiment. However, such omissions are not limiting.

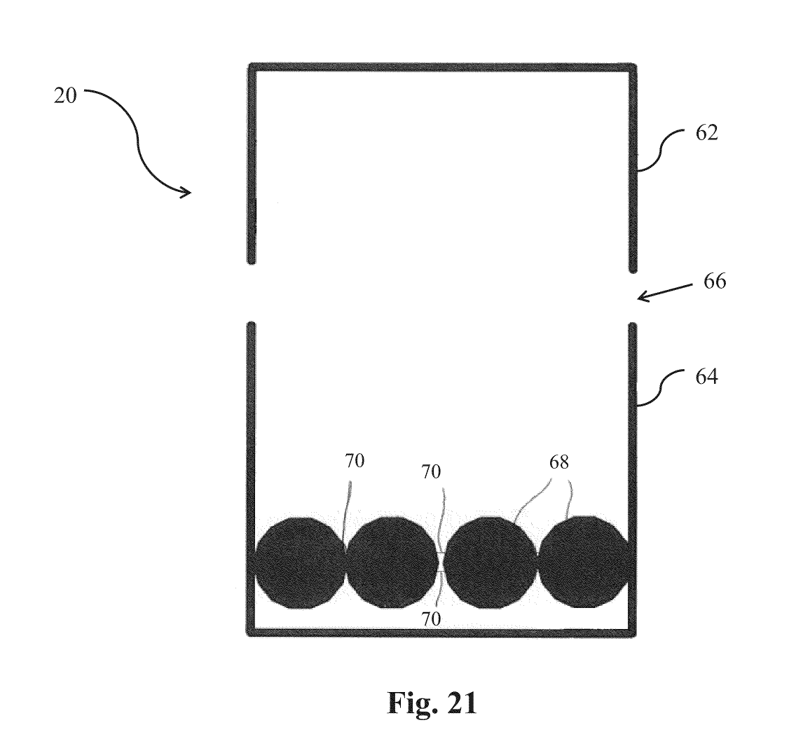

As shown in FIGS. 17 and 21, each slot, generally designated 20, can include a first or top half 62 and a second or lower half 64. A gap or spacing 66 can be created or exposed between the halves 62, 64 to receive at least a portion of one of the push bars and allow the push bar to move with respect to the collection bin 14. Further, the second half 64 can include at least one or a plurality of rollers or ball bearings 68 to facilitate movement of one or more masonry units 12 into and/or out of each slot 20, as described in detail below. The rollers 68 can be secured or generally held in place by one or more horizontally-extending bars 70 that run through each roller 68 and at least slightly into an interior wall of each slot 20. The bars 70 can extend generally, if not exactly, perpendicularly to the longitudinal axis A of the collection bin 14.

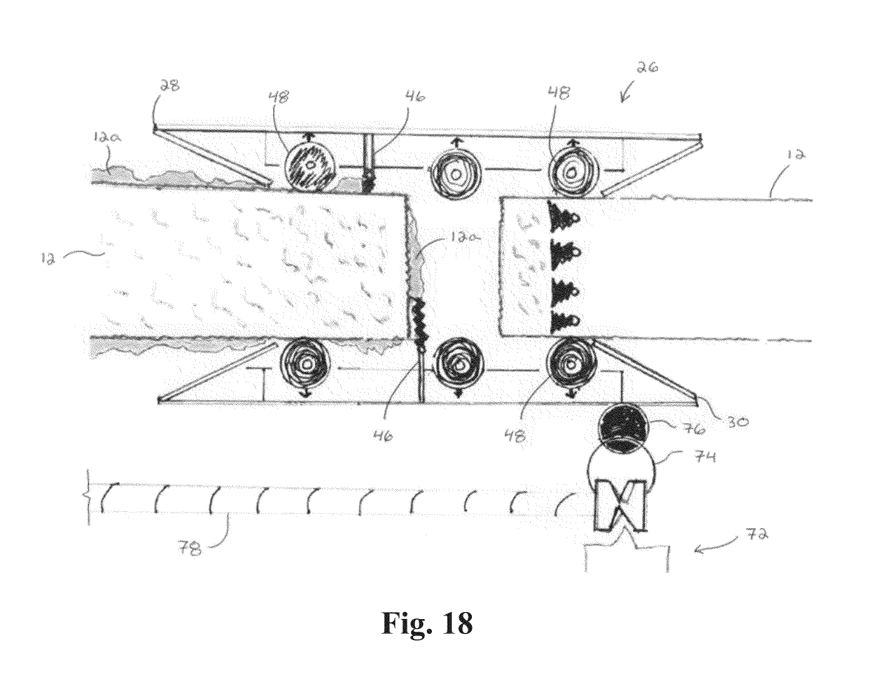

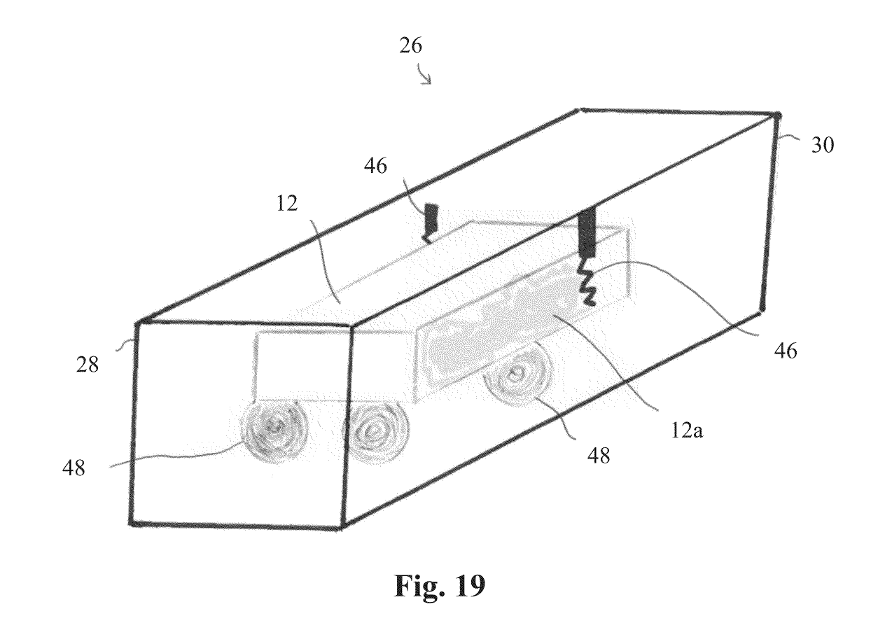

Referring to FIGS. 16-19, at least one mortar removal apparatus or box 26 can be configured to separate at least some mortar, grout or other debris 12a (see FIGS. 18 and 19) from one or more of the masonry units 12. As shown in FIG. 18, the mortar removal apparatus 26 can include an open first or front end 28, an open opposing second or rear end 30, and a passageway therebetween. The mortar removal apparatus 26 can be positioned proximate to the first end 16 of the collection bin 14, but the mortar removal apparatus 26 is not limited to such a location.

Referring specifically to FIG. 18, the mortar removal apparatus 26 can include at least one removal mechanism 46 within the passageway. The removal mechanism 46 can be configured to remove at least some at least partially hardened grout, mortar or other debris 12a from one or more of the masonry units 12. The removal mechanism 46 can be a laser, knife, chisel, diamond or the like. In one exemplary embodiment, two spaced-apart lasers 46 are positioned within the mortar removal apparatus 26 and face the interior thereof. One of the lasers 46 can be positioned to remove debris 12a from one or both ends of a masonry unit 12, while the other laser 46 can be positioned to remove debris 12a from one or more sides of a masonry unit 12.

The mortar removal apparatus 26 can also include at least two or more opposing rollers or ball bearings 48 within the passageway to facilitate passage of at least a single masonry unit 12 through the passageway. Each ball bearing 48 can be spring-loaded and biased inwardly or outwardly with respect to the passageway. In one exemplary embodiment, only a single masonry 12 unit can pass through the mortar removal apparatus 26 at any given time, although masonry units 12 can pass through the mortar removal apparatus 26 in a line, in-series manner (as shown in FIG. 18).

Referring specifically to FIG. 19, it may be desirable for the individual 56 to place the masonry units 12 on a conveyor 32 (as described in detail below) so that the two, opposing surfaces having mortar 12a thereon (referred to herein as the “dirty surfaces”) of each masonry unit 12 are exposed on the lateral sides (as opposed to the two, opposing “dirty surfaces” being positioned at the top and bottom, as shown in FIG. 18). Placing the masonry units 12 on the conveyor 32 so that one of its clean sides (e.g., side without any or significant mortar 12a) sits on or contacts the conveyor 32 helps ensure stability of each masonry unit 12 on the conveyor 32. In addition, if the two opposing “dirty surfaces” of each masonry unit 12 are on the lateral sides, the removal mechanisms 46 only have to cut off the remaining mortar 12a at its junction with the actual masonry unit 12 (with the remaining mortar falling off due to gravity), instead of having the removal mechanisms 46 ablate the entirety of the remaining mortar 12a. This embodiment of the mortar removal apparatus 26 is aimed at not only the above-mentioned stability factor, but also decreasing the burden on (and, therefore, cost of) each removal mechanism 46.

The mortar removal apparatus 26 can be laterally and/or vertically movable with respect to the collection bin 14 so as to at least generally align the second end 28 thereof with the first end 22 of any one of the slots 20. To permit or effectuate such movement, the system can include at least one guide bar or rail 52 (see FIG. 17) positioned proximate to the first end 16 of the collection bin 14. The guide bar 52 can be a solid wire or hollow cylindrical tube, for example, or the guide bar 52 can include prongs or grooves to receive at least a portion of the mortar removal apparatus 26. In one exemplary embodiment, the guide bar 52 includes at least generally straight midsections and at least generally arcuate end sections, such that the guide bar 52 moves in a compressed “S” or “8” shape from an upper portion to a lower portion of the first end 16 of the collection bin 14. The mortar removal apparatus 26 can engage or contact at least a portion of the guide bar 52 to move among or between the slots 20. In one exemplary embodiment, the system can include two guide bars 52, such that one of the guide bars 52 engages a first portion of the mortar removal apparatus 26 and the other guide bar 52 engages a second spaced-apart portion of the mortar removal apparatus 26. The mortar removal apparatus 26 can be separable or removable from the guide bar(s) 52, such as when not in use.

Referring again to FIG. 16, a gear box, generally designated 72, can also assist in permitting or effectuating movement of the mortar removal apparatus 26. At least one ring 74 and at least one ball bearing or roller 76 can connect the mortar removal apparatus 26 to at least a portion of the gear box 72. The ring 74 can be formed of a metallic material. A lever or rod 78 can extend outwardly from the mortar removal apparatus 26 and/or the gear box. Rotation or other movement of the lever 78 can allow the user or operator 56 to selectively move the mortar removal apparatus 26 with respect to the collection bin 14, for example.

As shown in FIG. 16, the system can include at least one debris removal chute 54 for receiving, collecting and/or moving any debris or mortar 12a that the mortar removal apparatus 26 receives or separates from any of the masonry units 12. The debris removal apparatus 54 can move laterally at or near the first end 16 of the collection bin 14 in a direction at least generally, if not exactly, perpendicularly to the longitudinal axis A. The debris removal chute 54 can engage, contact and/or receive at least a portion of the guide bar(s) 52 in a manner similar to that of the mortar removal apparatus 26. The debris removal chute 54 extends generally, if not exactly, perpendicularly to both the longitudinal axis A of the collection bin 14 and the platform 40 of the truck 38. A first or upper end of the debris removal chute 54 can be coupled to the mortar removal apparatus 26, and can be telescoping so as to collapse or extend as necessary. A second or lower end of the debris removal chute 54 can be positioned proximate to a container 80 to receive and/or at least temporarily store the debris. The container 80 can rest on or can be attached to the platform 40 of the truck 38.

As shown in FIGS. 1-4, a conveyor, belt or moving device 32 can extend away from the collection bin 14 and/or the first end 28 of the mortar removal apparatus 26. More particularly, the conveyor 32 can extend from a wall 58 of stacked masonry units 12 or a pile of loose masonry units 12 to, at least slightly into the collection bin 14 and/or the first end 28 of the mortar removal apparatus 26, or completely through the mortar removal apparatus 26. The conveyor 32 can be configured to supply or move at least one or a plurality of the masonry units 12 to and/or into the collection bin 14 and/or the mortar removal apparatus 26. The conveyor 32 can be operated by a motor, for example, or can employ gravity to quickly and effectively move the masonry units 12 from the wall 58 to the collection bin 14 and/or the mortar removal apparatus 26. The conveyor 32 can have a smooth top or exterior surface, or have vertical cleats to thereby engage at least a portion of a masonry unit 12.

An exemplary method of reusing or recycling one or more masonry units 12 can include receiving masonry units 12 in a linear manner. In particular, an individual 56 can separate and/or remove, either by hand or with machinery, masonry units 12 from the wall 58 and place the masonry units 12 on the conveyor 32. The “used” masonry units 12 can be placed on the conveyor 32 in a linear, end-to-end fashion. The conveyor 32 can move each masonry unit 12 to the collection bin 14 and/or the mortar removal apparatus 26.

In one embodiment, the mortar removal apparatus 26 can receive at least a portion of each masonry unit 12 placed on the conveyor 32 and can remove some or all debris 12a on the masonry units 12 (such masonry units 12 can be referred to herein as “cleaned” masonry units). Each masonry unit 12 can exit the mortar removal apparatus 26 at the second end 30 thereof, and each masonry unit 12 can slide, be pushed or inserted into one of the slots 20 of the collection bin 14 in a linear manner. The mortar removal apparatus 26 can be moved along the guide bar(s) 52 to align with and insert “cleaned” masonry units 12 into any of the slots 20 desired by the operator 56. Cleaned masonry units 12 can be inserted into individual slots 20 in a linear or consecutive manner until the slots 20 are full or until there are no more masonry units 12 to be processed. At this point, the mortar removal apparatus 26 and/or the debris removal chute 54 can be removed from the guide bar(s) 52.

Alternatively, in another embodiment, the “used” masonry units 12 can be cleaned prior to be being placed on the conveyor 32, such that the conveyor 32 carries the masonry units 12 to and/or into the collection bin 14. For example, a distal or head-end of the conveyor 32 can attach to one or more two-axis automated, indexable actuators that can move the distal end of the conveyor 32 from an opening of one storage chute 20 to the next or another. The actuators can be configured to move at least the distal end of the conveyor 32 both vertically and horizontally, as needed. The actuators can be powered by pneumatics, electricity, hydraulically or the like. Each storage chute 20 can have an infeed chute configured to accept the masonry units 12 from the head end of the conveyor 32 and guide the masonry units 12 to the storage chute 20 at the proper orientation needed for that chute 20. Each chute 20 can also allow for the discharge of undersized or broken masonry units 12. Each individual storage chute 20 can have a separate infeed chute, or a horizontal row of chutes 20 can index vertically to each row of storage chutes 20. The chutes 20 can use gravity to transfer the masonry units 12 or can have alternative actuation with a small conveyor or push device. The indexing row of chutes and alternative actuation can use pneumatic, electric or hydraulic power, for example.

A proximal or tail end of the conveyor 32 can be positioned at a low point near where the cleaning mechanism 82 (see FIGS. 1-9) can be located. The conveyor 32 can have a predefined range of motion at the head end to accommodate indexing to each chute 20, and to allow a range of placement options for the tail end. The head end can allow and/or limit rotation angles in both the horizontal and vertical planes, allowing the tail end to be placed on varying terrain and locations within the allowed radius of the conveyor motion.

A tail support, generally designated 84, can also allow rotation in both the horizontal and vertical axis to accommodate the motion of the head end as it moves to index to each individual storage chute 20. The tail support 84 can have a lower end that rests on the ground surface, for example, and an opposing upper end that supports the proximal end of the conveyor 32. The upper end of the tail support 84 can be rotatable with respect to the lower end thereof, which allows the user to more easily maneuver the conveyor 32 to a desired position and/or location with respect to the collection bin 14, for example. The upper end of the tail support 84 can include a bearing or roller to which the conveyor 32 can rotate around.

The lift 50 can be raised (manually or automatically) such that one or more pallets 60 (see FIG. 15) placed thereon is at least generally level with one or more of the slots 20. Each pallet 60 can be generally a flat surface with no upwardly extending sidewalls. The flat surface may have a length of approximately 48 inches and a width of approximately 33.5 inches. In one embodiment, each pallet 60 can include three upwardly extending sidewalls to generally confine the masonry units 12 therein, such that the pallet 60 is in the form of a three sidewall crate. Each sidewall may have a height of approximately 28 inches. A front opening may be approximately 41.5 inches wide to allow the masonry units to be more easily placed on the pallet 60.

Cleaned masonry units 12 can be ejected or removed from the slots 20 in a linear manner and pushed or placed onto the pallet 60, for example. The push bar(s) can be operated by the individual to effectuate such a result. As shown in FIGS. 10-15, the push bar(s) can be accessible to the individual on a side of the collection bin 14. In particular, the lift 50 can be lowered in successive increments to align with any particular row of slots 20 that contains cleaned masonry units 12. The cleaned masonry units 12 can be pushed onto the pallets 60 in successive levels or layers. Once a sufficient number of the cleaned masonry units 12 are placed on the pallet 60 in an organized manner, the lift 50 can be lowered so that the cleaned masonry units 12 are readily accessible for use in building another structure, for example, at or near the platform 40 of the truck 38. Thus, the present disclosure provides a method by which even a single individual can reuse or recycle masonry units 12.

In another embodiment, the storage chutes 20 can consolidate the masonry units 12 away from the infeed chutes, either by gravity or by using the actuation from the infeed chutes, if available. After a predetermined number of masonry units 12 are in the chutes 20, the push bar can contact the last masonry unit 12 in line and can be used to move the row section to the pallet 60. The push bar can be above or below the storage chute 20 and can have a width greater than one storage chute 20. The push bar(s) can be attached to a second conveyor or a push-pull device driven by pneumatics, hydraulics, electricity or the like.

Once at least a full pallet layer of masonry units 12 is in the storage chutes 20, the push bar can push the predetermined number of masonry units 12 from the respective storage chutes 20 into a consolidation chute that can squeeze or organize the masonry units 12 into an approximate rectangular shape that would make up a layer on a pallet. A secondary push bar can fully move the masonry units 12 into the consolidation chute with actuation provided by a conveyor or push/pull device.

The indexable vertical lift 50, actuated by pneumatics, hydraulics, electricity or the like, can raise a pallet 60 to a level just below the consolidation chute location. The push bar, either the same secondary one listed above or a separate bar, will push the consolidated masonry unit layer out onto the pallet 60. In most cases, the floor of the consolidation chute, or the entire chute 20, can extend with the push bar over the top of the pallet, and then this will retract while the push bar remains in place, depositing the layer of masonry units 12 on the pallet. This may require several push/pull actuation devices. Once the predetermined number of layers of masonry units 12 are placed on the pallet 60, the vertical lift 50 will lower to allow for wrapping (e.g., manually) of the stacked masonry units 12 with film or other material and to allow the loaded pallet 60 to be removed via forklift.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

I/We claim:

1. A system for reusing one or more masonry units, the system comprising:
a vehicle including at least one vertical lift, the lift being movable with respect to the vehicle from a lower, compact position to a higher, extended position;
at least one collection bin including a first end, an opposing second end, and a longitudinal axis extending therebetween, a plurality of elongated slots extending along the longitudinal axis of the collection bin, each slot including an open first end and an opposing second end, the first end of each slot being sized and shaped to receive at least one masonry unit therein, the collection bin being placed on the vehicle, the first end of the collection bin being positioned proximate to the vertical lift; and
a conveyor extending from proximate to one or more masonry units to proximate to the first end of the collection bin, the conveyor being configured to supply at least one of the masonry units to the collection bin.

2. The system of claim 1, wherein the plurality of slots are arranged in rows and columns.

3. The system of claim 1, wherein the vehicle is a flatbed truck.

4. The system of claim 1, further comprising:
a mortar removal apparatus configured to separate at least some mortar from one or more masonry units, the mortar removal apparatus being positioned proximate to the first end of the collection bin, the mortar removal apparatus including an open first end, an open opposing second end, and a passageway therebetween, the mortar removal apparatus being movable to at least generally align the second end thereof with the first end of any one of the slots

5. The system of claim 4, wherein the conveyor is a conveyor belt that extends from or near a wall of masonry units to the first end of the mortar removal apparatus.

6. The system according to claim 4, further comprising:
at least one guide bar positioned proximate to the first end of the collection bin,
wherein the mortar removal apparatus contacts at least a portion of the at least one guide bar to move among the slots.

7. The system according to claim 4, further comprising:
a debris removal chute extending perpendicularly to the longitudinal axis of the collection bin, the debris removal chute being coupled to the mortar removal apparatus.

8. The system of claim 4, wherein the mortar removal apparatus includes at least one removal mechanism within the passageway and at least two opposing bearings to facilitate passage of a brick through the passageway.

9. The system of claim 4, wherein the conveyor is a conveyor belt that extends from or near a pile of generally loose masonry units to the first end of the mortar removal apparatus.

10. The system of claim 1, wherein the lift is movable at least generally perpendicularly to the longitudinal axis of the collection bin.

11. The system of claim 10, wherein at least a top end of the lift is configured to receive the one or more masonry units ejected from the first end of the collection bin.

12. The system according to claim 1, further comprising:
at least one push bar extending into an interior of the collection bin, the push bar being movable with respect to the collection bin in a direction that is at least generally parallel to the longitudinal axis.

13. The system according to claim 1, further comprising:
a separating machine positioned proximate to a first end of the conveyor, the separating machine including a handle configured to actuate a blade to remove at least one of debris and grout from at least one of the masonry units.

14. A method of reusing masonry units, the method comprising:
receiving masonry units in a single file manner;
inserting a predetermined number of the masonry units into a first slot of a collection bin in a single file manner;
inserting a predetermined number of masonry units into a second slot of the collection bin in a single file manner, the first slot being adjacent to the second slot;
raising a pallet to be at least generally level with the first and second slots;
ejecting at least some of the masonry units from each slot in a single file manner onto the pallet, the masonry units being ejected to form an organized pattern on the pallet; and
lowering the pallet once a desired number of masonry units are placed thereon.

15. The method according to claim 14, further comprising:
removing at least some debris or grout from each of the masonry units prior to inserting the masonry units into the slot of the collection bin.

16. The method according to claim 15, wherein the collection bin is placed on a flatbed truck, and wherein the pallet is raised and lowered by a vertical lift.

17. The method according to claim 16, wherein a conveyor belt delivers the masonry units to the collection bin in a single file manner.

18. The method according to claim 17, wherein a blade is used to remove at least one of debris and grout from each masonry unit prior to being inserted into one of the first and second slots.

19. The method according to claim 18, further comprising:
removing the pallet of masonry units from a vehicle;
transporting the pallet of masonry units to a desired location; and
using the masonry units in one of a construction and landscaping project.

20. A system for reusing one or more masonry units, the system comprising:
a flatbed truck including at least one vertical lift, the lift being movable with respect to the flatbed truck from a lower, compact position to a higher, extended position;
at least one collection bin including a first end, an opposing second end, and a longitudinal axis extending therebetween, a plurality of elongated slots extend along the longitudinal axis of the collection bin, the plurality of slots are arranged in rows and columns, each slot including an open first end and an opposing second end, the first end of each slot being sized and shaped to receive at least one masonry unit therein, the collection bin being placed on the flatbed truck, the first end of the collection bin being positioned proximate to the vertical lift, the lift being movable at least generally perpendicularly to the longitudinal axis of the collection bin;
at least one push bar extending into an interior of the collection bin, the push bar being movable with respect to the collection bin in a direction that is at least generally parallel to the longitudinal axis;
a conveyor extending from proximate to one or more masonry units to proximate to the first end of the collection bin, the conveyor being configured to supply at least one of the masonry units to the collection bin; and
a separating machine positioned proximate to a first end of the conveyor, the separating machine including a handle configured to actuate a blade to remove at least one of debris and grout from at least one of the masonry units.
